(19) United States
(12) Patent Application Publication
(10) Pub. No.: US 2004/0186662 A1
(43) Pub. Date: Sep. 23, 2004

(54) Navigation system

(76) Inventor: Nobuhide Morie, Iwaki-city (JP)

Correspondence Address: BRINKS HOFER GILSON & LIONE, P.O. BOX 10395, CHICAGO, IL, 60610, US

(21) Appl. No.: 10/751,745

(22) Filed: Jan. 5, 2004

(30) Foreign Application Priority Data
Jan. 6, 2003 (JP) 2003-000622

(51) Int. Cl. G01C 21/32

(52) U.S. Cl. 701/208; 340/995.1

(57) ABSTRACT

In a navigation system, a detailed map of an area surrounding the vehicle is displayed in a window on a monitor on the scale designated by a user, and main roads extending outside the map displayed in the window are displayed in a deformed image around the window, so that the map of the surrounding area is displayed in detail, and only the main roads are simply displayed outside the window. This allows the user to grasp detailed information about the area surrounding the vehicle, main roads ahead of the vehicle, and the connections between the vehicle and the main roads at a glance at a single window.

### BACKGROUND OF THE INVENTION

1. Field of the Invention

The present invention relates to an on-vehicle navigation system that performs vehicle route guidance so that a driver can easily reach a desired destination.

2. Description of the Related Art

In navigation systems that perform vehicle route guidance, the current position of the vehicle is generally detected by using a self-contained navigation sensor, a GPS (global positioning system) receiver, and the like, and map data corresponding to an area surrounding the detected position. The map data is read from a recording medium such as a DVD (digital versatile disc). A map image is displayed on a display device using the map data, and a vehicle position mark is superimposed at a predetermined position of the map image. As the current position changes with the movement of the vehicle, the vehicle position mark is moved on the screen, or a map image adjacent to the vehicle is scrolled while the vehicle position mark is fixed at a given point on the screen. Accordingly, the driver can check at a glance where the vehicle is.

Map data is classified for management into levels from higher level map data containing data on a wide area to lower level map data containing detailed data on a smaller area. Each level is classified into rectangular regions. Each region is managed in units so that the amount of data contained in each unit is uniform. In most navigation systems, the map can be displayed on the scale requested by the user on the basis of such map data.

For example, when a small display scale is selected, only a map of a small area surrounding the vehicle is displayed in detail on the screen. Since detailed information, such as detailed shapes of roads and buildings, simple addresses, one-way indications, and signals, is displayed in such a detailed map, the user can drive while checking such information. In contrast, when a large display scale is selected, only a wide-area map, main landmarks, and the like are displayed. In this case, the user can drive while checking the shapes of both the road along which the vehicle travels and the peripheral roads.

Japanese Unexamined Patent Application Publication No. 2002-71362 discloses a navigation system that permits a map display in a mode designated by the user, for example, a map display based on railways (for example, the positions and names of railways and the station names are displayed), or a map display based on main highways (for example, main roads, junction points, and the names of cities at which the main roads begin are displayed). Furthermore, Japanese Unexamined Patent Application Publication No. 5-313568 discloses a navigation system that displays the end points of roads displayed on the map.

The user generally drives by using main roads as guides. For example, the user frequently recognizes the current position of the user's vehicle on the basis of the peripheral main roads, for example, the user thinks “I will turn to the right along XX Street extending ahead”, or “I will continue driving along this road because this road extends along the right side of YY Street”. This particularly applies to regions in which roads are laid in a grid pattern.

However, in a detailed map displayed on the small scale, the user can confirm detailed information about the periphery of the vehicle, but cannot confirm a main road to which the traveling road the user is currently driving on is connected ahead and main roads extending on the right and left sides of the traveling road, because the main roads are not displayed. In a wide-area map displayed on the large scale and the map based on the main highways, as in the above publication Japanese Unexamined Patent Application Publication No. 2002-71362, the shapes of most roads including peripheral main roads can be recognized, but detailed information about an area surrounding the vehicle can hardly be recognized, although the user wants such information most of all.

Some navigation systems enable two-window display in which different maps are displayed on two split windows of a monitor screen. By displaying a detailed map and a wide-area map in the respective windows, both detailed information about the surroundings of the vehicle and information about the shapes of roads in the wide area including peripheral main roads can be simultaneously displayed.

In such a two-window display, however, information, such as roads, characters, landmarks, and polygons, is displayed on both the detailed map and the wide-area map. For this reason, much unnecessary information is displayed on the monitor display screen, which is not so large, and this hinders the user from grasping essential information.

Furthermore, because each window has half the size of the monitor screen, the monitor screen must be large. Moreover, when the monitor screen is vertically or horizontally split into two, the aspect ratio is changed, and the maps displayed in the windows are hard to see. In addition, the user must compare the detailed map and the wide-area map while changing the viewpoint in order to check the correspondence therebetween. This is quite troublesome.

### SUMMARY OF THE INVENTION

The preferred embodiment of the present invention has been made to overcome the above problems, and an object of the present invention is to allow a user not only to easily recognize detailed information about an area surrounding the vehicle, but also to easily grasp beforehand information about the positional relationships between the vehicle and peripheral main roads.

In order to achieve the above object, according to one aspect of the present invention, a navigation system is provided in which a map image is displayed in a window of a monitor screen on the scale designated by a user, and a main road extending outside a map area corresponding to the window is displayed as a simple map image around the window. Preferably, the main road is displayed with the name thereof in the simple-map image.

In the preferred embodiment of the present invention, the area surrounding the vehicle is displayed in detail, and an outer area is displayed so that only main road is simply shown. Moreover, a detailed map surrounding the vehicle and a simple map around the detailed map are displayed in a single window in good connection. Accordingly, the user can easily acquire detailed information about an area surrounding the vehicle, and can recognize main roads extending ahead of the vehicle beforehand. The user also can easily grasp the positional relationships between the vehicle and the peripheral main roads at a glance at a single window.

Further objects, features and advantages of the present invention will become apparent from the following description of the preferred embodiments with reference to the attached drawings.

### BRIEF DESCRIPTION OF THE DRAWINGS

FIG. 1 is a block diagram showing the configuration of a navigation system according to an embodiment of the present invention;

FIGS. 2A to 2C are explanatory views showing examples of navigation windows;

FIGS. 3A and 3B are explanatory views showing other examples of navigation windows; and

FIG. 4 is a flowchart showing the operation of a simple-map drawing unit in the embodiment.

### DESCRIPTION OF THE PREFERRED EMBODIMENTS

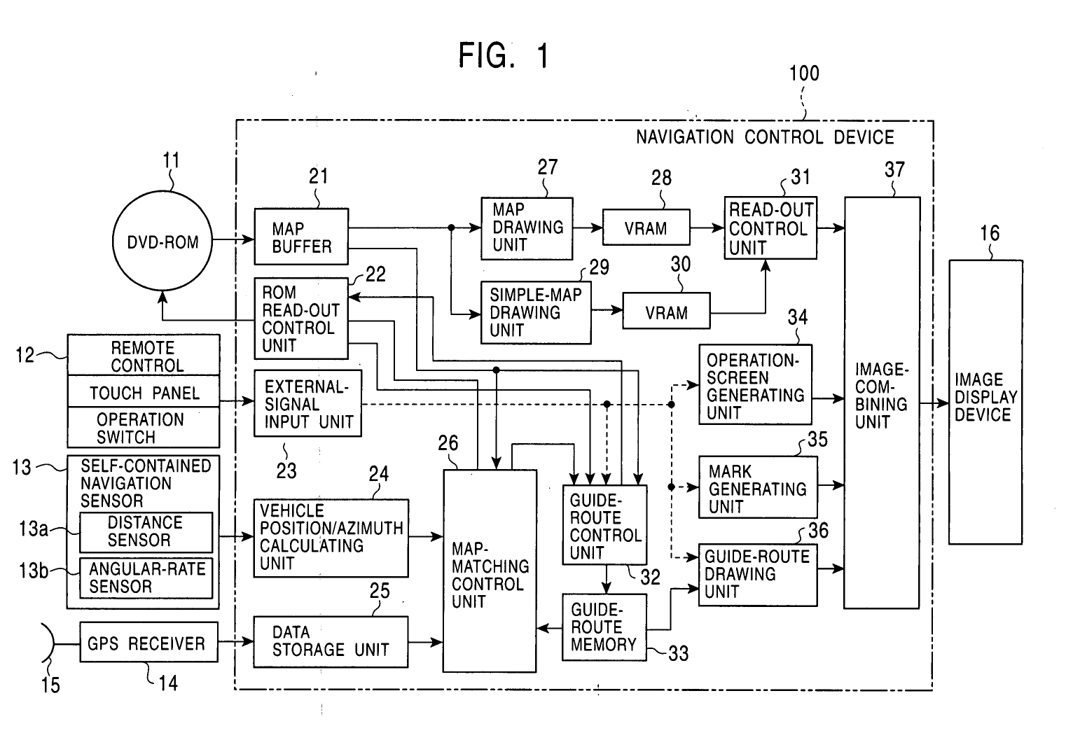

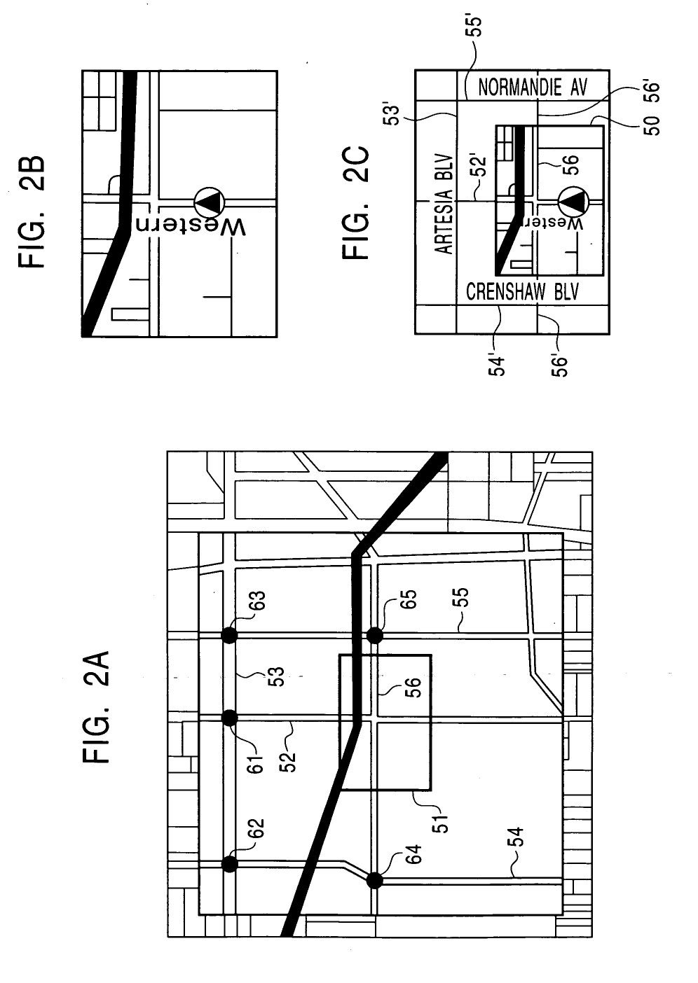

An embodiment of the present invention will be described below with reference to the attached drawings. FIG. 1 is a block diagram showing the configuration of a navigation system according to the embodiment, and FIGS. 2A and 2B are explanatory views showing examples of navigation windows in the embodiment. First, the features of this embodiment will be briefly described in comparison with a known navigation system.

FIG. 2A shows an image of a part of map data stored in a navigation system. In the known navigation system, a map of an area surrounding a vehicle is cut out and is displayed over the entire monitor screen, as shown in FIG. 2B, on the basis of map data in a layer selected in accordance with the scale designated by the user.

In contrast, in the navigation system of this embodiment, as shown in FIG. 2C, a map image in accordance with the designated scale is displayed in a window 50 provided at a predetermined position on the monitor screen (for example, at almost the lower center of the screen). Moreover, main roads connected outside the map image, and the names of the roads are simply displayed as a deformed image, and the deformed image is displayed around the window 50.

Herein, main roads refer to roads above a given rank in road categories. For example, in Japan, roads are classified into the following ranks: from the highest rank, (1) national expressways, (2) city expressways, (3) national roads, (4) main local roads, (5) main local roads (designated city roads), (6) prefectural roads, (7) main ordinary roads, (8) ordinary roads, (9) narrow roads, (10) ferry routes, (11) car train tracks, and (12) others. In this embodiment, for example, roads of the ranks (1) to (4) are defined as main roads.

In the United States, Navigation Technologies Corporation classifies a road network into five function classes FC1 to FC5, namely, superhighways FC1, highways FC2, Collector Roads FC3, feeder roads FC4, and local streets FC5. For example, the roads FC1 to FC3 are defined as main roads.

The configuration of the navigation system of this embodiment will be described with reference to FIG. 1. Referring to FIG. 1, a navigation control device 100 controls the entire navigation system, and a DVD-ROM 11 serving as a recording medium stores various map data necessary, for example, for map display and route search. While the DVD-ROM 11 is used as a recording medium in this embodiment, another recording medium, such as a CD-ROM or a hard disk, may be used.

Map data stored in the DVD-ROM 11 includes a background unit and a character and sign unit containing various data necessary for map display, a road unit containing data necessary for various processing operations such as map matching and route search, which will be described later, and an intersection unit containing detailed data on intersections.

The road unit contains node information corresponding to the points at which a plurality of roads cross, such as intersections and junction points, and link information corresponding to roads, lanes, and the like. A link record that stores detailed information about the links contains information about road type flags. A road type flag represents the type of an actual road corresponding to a link. Accordingly, it is possible to determine, on the basis of the road type flag, whether the road is a main road.

An operating section 12 includes a remote control, a touch panel, operation switches, and so on, and allows the user to input information (e.g., a destination and a pass point for route guidance) to the navigation control device 100 and to perform various operations (e.g., menu selection, map reduction/enlargement, manual map scrolling, and numeric entry).

A self-contained navigation sensor 13 measures the current position of the vehicle, and includes a distance sensor (speed sensor) 13a for detecting the moving distance of the vehicle by outputting on every time the vehicle moves by a predetermined distance, and an angular-rate sensor (relative-azimuth sensor) 13b, such as a vibrating gyroscope, for detecting the rotation angle (moving azimuth) of the vehicle. The self-contained navigation sensor 13 detects the relative position and azimuth of the vehicle by the distance sensor 13a and the angular-rate sensor 13b, and outputs information about the position and azimuth to the navigation control device 100.

In order to measure the current position of the vehicle, a GPS receiver 14 receives radio waves transmitted from a plurality of GPS satellites through a GPS antenna 15, and calculates the absolute position and azimuth of the vehicle by three-dimensional position measurement processing or two-dimensional position measurement processing (the azimuth of the vehicle is calculated on the basis of the vehicle position at the present time and the vehicle position one sampling time ΔT before). The GPS receiver 14 then outputs information about the calculated absolute position and azimuth of the vehicle with the time of position measurement to the navigation control device 100.

An image display device 16 displays images generated under the control of the navigation control device 100. A map of an area surrounding the vehicle is displayed with a vehicle position mark and so on in a window 50 at almost the center of a screen of the image display device 16. A guide route is displayed on the map, and an enlarged image of a guide intersection is also displayed when the vehicle comes near the intersection. Main roads are displayed as a simple image around the window 50 (see FIG. 2C).

In the internal configuration of the navigation control device 100, a map buffer 21 temporarily stores map data read from the DVD-ROM 11. A ROM read-out control unit 22 controls the reading-out of the map data from the DVD-ROM 11.

That is, the ROM read-out control unit 22 receives information about the current position of the vehicle subjected to map matching from a map-matching control unit 26 which will be described later, and outputs instructions to read out map data on a predetermined area including the current position of the vehicle. In response thereto, map data necessary for map display and guide-route search is read from the DVD-ROM 11 and is stored in the map buffer 21.

An external-signal input unit 23 receives from the operating section 12 a control signal in accordance with the operation. A vehicle position/azimuth calculating unit 24 calculates the absolute position (estimated vehicle position) and azimuth of the vehicle on the basis of data on the relative position and azimuth of the vehicle output from the self-contained navigation sensor 13. A data storage unit 25 sequentially stores data on the absolute position and azimuth of the vehicle output from the GPS receiver 14.

The above-described map-matching control unit 26 corrects the position of the vehicle on the map data road by performing map matching, for example, in a projective method every time the vehicle moves by a predetermined distance, on the basis of map data stored in the map buffer 21, data on the estimated position and azimuth of the vehicle calculated by the vehicle position/azimuth calculating unit 24 based on the information from the self-contained navigation sensor 13, and data on the position and azimuth of the vehicle output from the GPS receiver 14 and stored in the data storage unit 25.

A map drawing unit 27 generates map image data necessary to display the map on the scale designated by the operation of the operating section 12 in the window 50 of the monitor screen of the image display device 16. A VRAM (video RAM) 28 temporarily stores the map image data generated by the map drawing unit 27.

A simple-map drawing unit 29 generates simple-map image data necessary to simply display main roads connected outside the map area displayed in the window 50, on the basis of the map data stored in the map buffer 21. A VRAM 30 temporarily stores the simple-map image data generated by the simple-map drawing unit 29.

Simple-map image data generated by the simple-map drawing unit 29 will be more specifically described with reference to FIGS. 2A and 2C. The simple-map drawing unit 29 extracts a traveling road 52 along which the vehicle travels, a nearest main road 53, and left and right main roads 54 and 55 that extend outside a map area 51 corresponding to the window 50, as shown in FIG. 2A, and draws the roads as a deformed map image, as shown by roads 52′ to 55′ in FIG. 2C. The roads 52′ to 55′ are shown with their names.

The nearest main road 53 refers to a main road that first crosses the traveling road 52 of the vehicle outside the map area 51 and ahead of the vehicle. The left and right main roads 54 and 55 refer to other main roads that extend outside the map area 51 and that cross the main road 52 ahead at intersections 62 and 63 on the left and right sides of an intersection 61 of the traveling road 52 and the nearest main road 53.

When there is a main road 56 (in-area main road) 56 that crosses the traveling road 52 ahead of or behind the vehicle inside the map area 51, a portion of the in-area main road 56 extending outside the map area 51 is displayed as a stimulated road 56′ in FIG. 2C.

In FIG. 2C, the main roads 52′ to 56′ are schematically shown as a simple map image outside the window 50, for example, by straight lines, regardless of the actual shapes thereof. Furthermore, the main roads 52′ to 56′ are fixed at the same positions, regardless of the distances to the vehicle.

The road 56′ extending outward from the in-area main road 56 inside the window 50 may be vertically moved in accordance with the movement of the in-area main road 56. That is, the map image is scrolled through with the traveling of the vehicle and the in-area main road 56 is also vertically moved inside the window 50. Correspondingly, the road 56′ may be vertically moved so that it can look to be connected to the in-area main road 56 in an appropriate manner.

The simple-map drawing unit 29 changes the shape of the deformed map image depending on the number of intersections and number of road links on the nearest main road 53 and the left and right main roads 54 and 55. In the example shown in FIG. 2A, there are five intersections, namely, the intersection 61 of the traveling road 52 and the nearest main road 53, the intersections 62 and 63 of the nearest main road 53 and the left and right main roads 54 and 55, and the intersections 64 and 65 of the left and right main roads 54 and 55 and the in-area main road 56. In this case, the five intersections 61 and 65 are connected by straight lines, and are schematically displayed, as shown in FIG. 2C.

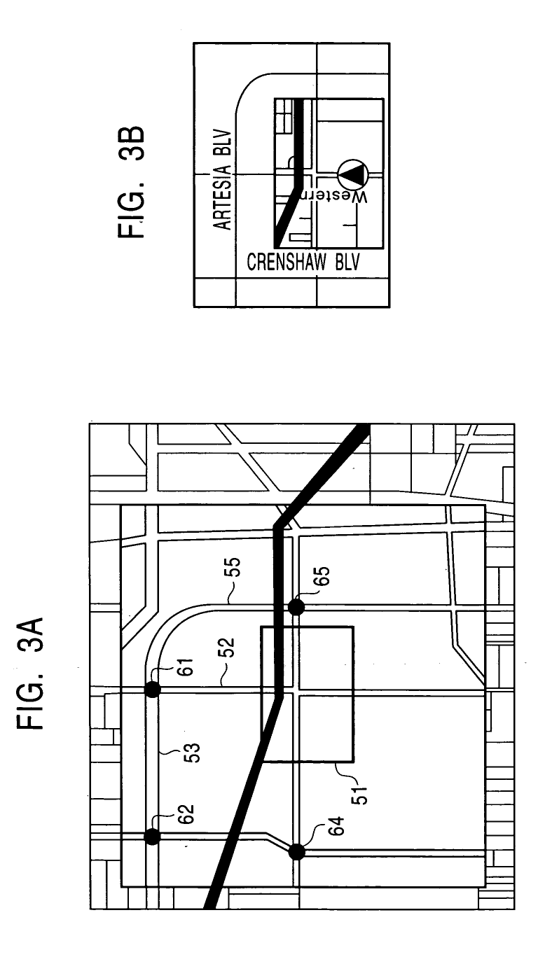

In contrast, for example, in a case in which the nearest main road 53 is curved at the right front side and is connected to the right main road 55 and there is no intersection between the nearest main road 53 and the right main road 55, as shown in FIG. 3A, the nearest main road 53 is displayed, as shown in FIG. 3B.

Furthermore, the simple-map drawing unit 29 draws, in a deformed map image, only main roads which satisfies the condition that the distances from the vehicle to the intersections 61 to 65 should be within a predetermined range (for example, three miles or less in the united states). Therefore, when the distance from the vehicle to the intersection 63 is more than three miles, the road 55′ corresponding to the right main road 55 is not drawn. This is because the distances between the main roads are three miles or less in the urban area in most cases, and because it is hardly necessary to do driving in consideration of the main roads in the provincial area.

Description will be given again with reference to FIG. 1. A read-out control unit 31 controls the reading-out of map image data and simple-map image data from the VRAMS 28 and 30. That is, map image data generated by the map drawing unit 27 is temporarily stored in the VRAM 28, and a part of the data corresponding to one window is read by the read-out control unit 31. Simple-map image data generated by the simple-map drawing unit 29 is temporarily stored in the VRAM 30, and is read by the read-out control unit 31.

A guide-route control unit 32 searches for a guide route that links the current position and the destination with the highest cost efficiency, on the basis of the map data stored in the map buffer 21. A guide-route memory 33 stores data on the guide route (a set of nodes from the current position to the destination) set by the guide-route control unit 32.

That is, when the destination is set for route search through the operating section 12, the guide-route control unit 32 stores data on the destination in the guide-route memory 33. When route search is requested through the operating section 12, the guide-route control unit 32 stores, as departure data, the position of the vehicle corrected by the map-matching control unit 26 into the guide-route memory 33. Subsequently, the guide-route control unit 32 searches for a route that links the departure point and the destination stored in the guide-route memory 33 under a predetermined condition, and stores the search result in the guide-route memory 33.

An operation-screen generating unit 34 generates and outputs an operation screen necessary to perform various operations through the operating section 12. A mark generating unit 35 generates and outputs, for example, a vehicle position mark that is displayed at the current vehicle position corrected by map matching, and various landmarks of gas stations, convenience stores, and so on.

A guide-route drawing unit 36 generates data on a guide route to be drawn according to the search result stored in the guide-route memory 33. That is, the guide-route drawing unit 36 selectively reads data included in the map area drawn in the VRAM 28, from the guide-route data stored in the guide-route-memory 33, and highlights on the map image a guide route by a bold line of a predetermined color other than the color of other roads.

An image-combining unit 37 superimposes, on the map image data read from the VRAM 28 by the read-out control unit 31, image data read from the operation-screen generating unit 34, the mark generating unit 35, and the guide-route drawing unit 36 to produce an image to be displayed in the window 50. The image-combining unit 37 also puts the simple-map image data read from the VRAM 30 by the read-out control unit 31 around the combined image data, and outputs the obtained image data to the image display device 16. Consequently, a combined image shown in FIG. 2C is displayed on the screen of the image display device 16.

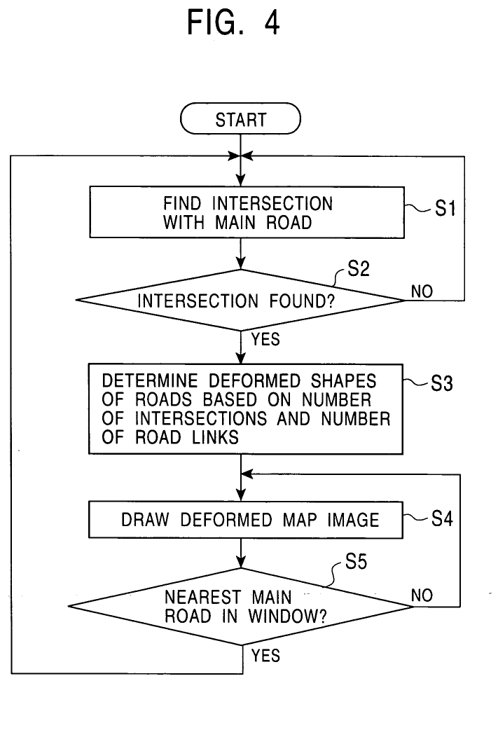

A detailed description will be given of an operation of the above-described simple-map drawing unit 29 for generating simple-map image data. FIG. 4 is a flowchart showing the operation of the simple-map drawing unit 29.

In FIG. 4, on the basis of the map data stored in the map buffer 21, the simple-map drawing unit 29 finds an intersection within a distance of three miles from the current position of the vehicle from a maximum five intersections around the vehicle on the traveling road 52, the nearest main road 53, and the left and right main roads 54 and 55, such as the intersections 61 to 65 shown in FIG. 2A or the intersections 61, 62, 64, and 65 shown in FIG. 3A (act S1).

Subsequently, the simple-map drawing unit 29 determines whether at least one intersection that satisfies the condition is found (act S2). When such intersection is found, the shapes of roads in a deformed map image are determined in accordance with the number of intersections and number of road links linking the intersections (act S3). Deformed map image data on the main roads are generated using the determined road shapes, and is stored in the VRAM 30 (act S4).

The deformed map image data stored in the VRAM 30 is read out by the read-out control unit 31, is combined with the map image data in the window 50 by the image-combining unit 37, and is displayed on the image display device 16. While the deformed map image except for the road 56′ is fixed, as described above, it is updated when the nearest main road 53 enters the map area in the window 50 as the vehicle travels.

For that purpose, the simple-map drawing unit 29 detects whether the nearest main road 53 has entered the map area of the window 50 (act S5). Until the nearest main road 53 enters the map area, act S4 is performed again to sequentially update the deformed map image data so that the road 56′ can look as if it moved with the movement of the in-area main road 56 in the window 50.

In contrast, when the nearest main road 53 enters the map area of the window 50, the above-described acts S1 to S5 are performed again. In this case, when the number of detected intersections is equal to the number of the intersections detected previously, only the display of the road names is apparently changed. When the number of the detected intersections changes, the deformed shapes of the roads are also updated.

In a case in which an intersection with the main road that satisfies the condition is not found within a distance of three miles from the vehicle in act S2, act S1 is performed again, and a similar operation is repeated until a relevant intersection is found. During the operation, the main roads are not displayed in the deformed map image. When an intersection is found later within a distance of three miles from the vehicle while the vehicle is traveling, act S3 is performed.

As described in detail above, in this embodiment, both a detailed map of the area surrounding the vehicle and a simple map containing the main roads connected outside the detailed map are displayed on the single screen. Therefore, the user can confirm detailed information about the area around the vehicle, and can also easily recognize main roads ahead beforehand.

In particular, since the peripheral main roads are shown in a deformed map image in this embodiment, the screen display is not complicated. Moreover, because the map image in the window 50 and the peripheral deformed map image do not overlap with each other, the screen does not contain unnecessary information, but contains only information necessary for the user. Therefore, the screen is easily viewable. In addition, the navigation screen that is not so large can be used effectively.

Because the detailed map and the simple map are displayed on the single screen, a large-screen monitor is unnecessary. Moreover, since the aspect ratio does not change, the maps can be easily viewed, which is different from the two-window display. Furthermore, there is no need to compare two windows while changing the viewpoint in order to check the relationship between the detailed map and the wide-area map, and the connection between the detailed map and the peripheral main roads can be intuitively grasped at a glance at the single screen.

While the main roads are displayed in a deformed map image in the above embodiment, a wide-area map image may be displayed. In this case, the amount of information to be displayed is increased. However, advantages that cannot be achieved by the two-window display can be provided, for example, a large-screen monitor is unnecessary, the map is easily viewed since the aspect ratio is not changed, there is no need to change the viewpoint to compare the detailed map and the wide-area map.

In the above embodiment, in a case in which an intersection with the main road is not found within a predetermined distance from the vehicle, the main road is not displayed in the deformed map image until an intersection is found. However, for example, when such an intersection is not found, the screen may be automatically switched to display a map image on the scale designated by the user over the entire screen on the basis of the map image data read from the VRAM 28. Conversely, when an intersection is found, the screen may be switched to display a combination image of the detailed map in the window 50 and the surrounding deformed map.

In such a case, when the scale is designated so that an area above a predetermined distance from the vehicle is displayed, most intersections with the main roads outside the map area are disposed above the predetermined distance from the vehicle. Therefore, the screen is switched to display the map image on the scale designated by the user over the entire monitor screen. In this way, switching is automatically made to produce a proper screen display depending on the designated scale.

When generating a deformed map image, intersections with the main roads may be found without limiting the distance from the vehicle.

The present invention is applicable not only to the above case in which the traveling road 52 of the vehicle is a main road, but also to a case in which the traveling road 52 is not a main road.

While the present invention has been described with reference to what is presently considered to be the preferred embodiment, it is to be understood that the invention is not limited to the disclosed embodiment. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A navigation system comprising:
a monitor screen operable to display images;
a map-image drawing unit operable to generate map image data for presentation of a map image in a window on the monitor screen;
a simple-map drawing unit operable to generate simple-map image data for presentation of a simple map image of a main road extending outside of the window; and
an image combining unit operable to display the map image inside the window and the simple image of the main road outside of the window on the monitor screen;
wherein the map image in the window is presented in greater detail than the simple map image located outside of the window.

2. The navigation system of claim 1, wherein a name corresponding to the main road is displayed on the simple map image.

3. The navigation system of claim 1, wherein the main road has a rank higher than or equal to the rank of collector roads.

4. The navigation system of claim 1, wherein the simple map image is a deformed map image that schematically shows a traveling road along which a vehicle drives, a nearest main road that first crosses the traveling road ahead of the vehicle outside the map area, and right and left main roads that extend outside the window and that cross the nearest main road at intersections on the right and left sides of an intersection of the traveling road and the nearest main road.

5. The navigation system of claim 4, wherein the simple-map image drawing unit schematically shows the nearest main road and the right and left main roads by straight lines.

6. The navigation system of claim 4, wherein the simple-map image drawing unit changes the shape of the deformed map image depending on the number of intersections and the number of road links on the nearest main road and the right and left main roads.

7. The navigation system of claim 4, wherein when an in-area main road crossing the traveling road ahead of or behind the vehicle is inside the window, the simple-map drawing unit schematically draws an outer portion of the in-area main road protruding from the map area so that the outer portion moves with the movement of an inner portion of the in-area main road lying in the window.

8. The navigation system of claim 4, wherein the simple-map drawing unit detects whether the nearest main road enters the window. .

9. The navigation system of claim 8, wherein the simple-map drawing unit updates the deformed map image when the nearest main road enters the map area.

10. The navigation system of claim 4, wherein the nearest main road and the right and left main roads are drawn in the simple-map image only when the main roads have an intersection within a predetermined distance from the vehicle.

11. The navigation system of claim 10, wherein when none of the main roads have an intersection within the predetermined distance from the vehicle, the monitor screen is switched to display the map image on the designated scale on the entire monitor screen on the basis of the map image data generated by the map-image drawing unit.

12. A navigation system comprising:
a monitor screen operable to display a map image;
a window portion provided at a predetermined position on the monitor screen operable to display a map image generated in a designated scale;
an simple image potion of the monitor screen external to the window portion operable to display a simple map image of a main road extending outside a the window.

13. The navigation system of claim 12, wherein the simple map image is generated on the basis of a wide-area map.

14. A method for displaying map image information, said method comprising the acts of:
providing a vehicle;
providing a navigation system inside said vehicle, said navigation system including a monitor screen operable to display map images;
identifying intersections with a main road within a predetermined distance of the vehicle;
determining shape of road based on the intersections and on road links linking the intersections;
generating simplified map data for display outside of a predetermined portion of said monitor screen.

15. The method of claim 14 wherein the predetermined distance is three miles.

16. The method of claim 14 further comprising the act of detecting whether a nearest main road has entered the predetermined portion of the monitor screen.
